(19) United States
(12) Patent Application Publication
(10) Pub. No.: US 2012/0024845 A1
(43) Pub. Date: Feb. 2, 2012

(54) EXOTHERMIC ENAMEL GLAZE, AND EXOTHERMIC CONTAINER COATED WITH SAME

(75) Inventors: Young-Goo Lee, Busan (KR); Suk-Shun Yoon, Busan (KR); Weon-Hyeon Park, Busan (KR); Hyun-Kyu Shin, Busan (KR); Young-Min Son, Busan (KR)

(73) Assignee: YOU&I TECH CO., LTD., BUSAN (KR)

(21) Appl. No.: 13/262,939

(22) PCT Filed: Mar. 10, 2010
(86) PCT No.: PCT/KR2010/001099

§ 371 Date: Oct. 5, 2011

(30) Foreign Application Priority Data
Apr. 6, 2009 (KR) 10-2009-0029558

(51) Int. Cl. H05B 6/80; B32B 5/16

(52) U.S. Cl. 219/725; 220/573.1; 428/570

(57) ABSTRACT

The present invention relates to a heating vessel used in a microwave oven for cooking a food using a magnetron. In the heating vessel that is heated by absorbing some of a high frequency generated from the magnetron so that a food in the cooking room of the microwave oven can be cooked by a high frequency, the heating enamel glaze is fabricated, the fabricated heating enamel glaze is coated on the vessel made of metal material for enamel (a steel plate, aluminum, or stainless for low carbon enamel), dried, and then subjected to glassification plasticity and cooled, thus producing the heating enamel vessel for a microwave oven. Accordingly, the heating enamel vessel can withstand temperature higher than the existing heating vessel product (silicon rubber+ferrite) and can have high heating performance. In a method of fabricating the heating enamel glaze, ferrite (MnZn series, MgCuZn series, NiZn series) having high transmittance and metal soft magnetic material (Fe—Si series, Fe—Si—Al series, Fe—Si—B series Fe—Si—B—Co series, Fe—Ni series, etc.) alloy powder are mixed and added to a glaze (glassy frit) commercially used for enamel processing. Accordingly, the heating enamel glaze having a heating characteristic in which a microwave oven absorbs a microwave (2.45 GHz) and converts it into heat energy is fabricated.

### TECHNICAL FIELD

The present invention relates to a heating vessel used in a microwave oven for cooking a food using a high frequency, oscillated in a magnetron, and a heating enamel glaze coated on the heating vessel and, more particularly, to the heating vessel of a microwave oven, which is capable of improving a heating characteristic and a heat-resistance property that withstands a higher temperature than the existing product by fabricating the heating vessel having a food mounted thereon by mixing heating material that generates heat by absorbing electromagnetic waves in an enamel glaze when a common enamel vessel is fabricated.

### BACKGROUND ART

In general, the microwave oven is a tool for cooking a food by vibrating the arrangement of molecules of a food by radiating a high frequency of 2.45 GHz, oscillated in the magnetron, to a cooking room.

There is an increasing tendency toward a microwave oven also playing the role of the existing electrical oven because a recent complex type microwave oven includes a hot wire in the cooking room of a microwave oven. Accordingly, there is a need for a heating cooking vessel which can withstand high temperature because temperature within the cooking room of the microwave oven is raised and directly transferred from the hot wire to a vessel and thus the temperature is raised up to 300 or higher.

Most of the recent heating cooking vessels, however, are used in forms in which ferrite is mixed in silicon or rubber so that a high frequency is absorbed and converted into heat and then attached to the bottom of an aluminum or common enamel vessel. Accordingly, the recent heating cooking vessels are problematic in that they are vulnerable to heat and difficult to be used in the microwave oven combined with an electrical oven in which the hot wire is provided in the cooking room.

A method of assigning a heating function to be used for the above purpose includes the following methods.

(1) This is the common method of mixing ferrite in silicon or rubber and attaching the mixture to the bottom of an aluminum or enamel vessel. If the heating vessel using this method is heated using a microwave oven of 1000 W for 3 minutes, heating temperature does not rise to 250 or higher, but deformation is generated in temperature of 260 or higher because the heating vessel is made of rubber material. Accordingly, there is a disadvantage in that the heating vessel cannot be used in high temperature.

(2) Japanese Patent Application Publication No. Hei4-144198 discloses a heating vessel for a microwave oven in which an attenuation agent using including high dielectric material having relative dielectric constant of 50 or higher and high dielectric material having relative dielectric constant of 50 or lower as dispersoid is laminated, the high dielectric material is strontium titanate, and the high dielectric constant tangent material is silicon carbide-titanium carbon solid.

The conventional heating vessel for a microwave oven has an effect that it has a thin thickness and may raise heating temperature by a combination of the high dielectric material and the low dielectric material, but is problematic in that if it is used for a long time as described above, oil dregs remaining in adhesion portions are carbonized to generate local discharge because a progressing agent and the attenuation agent are laminated on the bottom of a metal plate and the progressing agent and the attenuation agent are separated from the metal plate owing to discharge.

(3) In Korean Patent Application Publication No. 1995-027690 discloses a heating vessel for a microwave oven, including a vessel made of glass or ceramic material that can transmit a high frequency and a heating film coated on the bottom of the vessel through a chemical combination and configured to generate heat by absorbing a high frequency. The heating vessel is a thin film formed by using tin (Sn), manganese (Mn), magnesium (Mg), antimony (Sb), etc. as main raw materials in a high temperature of 500 or higher through a chemical combination so that it can generate heat by absorbing a high frequency and is different from common coating, painting, or plating. However, the heating vessel is disadvantageous in that the vessel may be damaged upon handling and the weight is heavy when the vessel is large because glass and ceramic material transmitting electromagnetic waves are used.

As described above, the methods of implementing heating vessels for microwave ovens, being used so far, are problematic in terms of use temperature, handling convenience, and the manufacturing cost, and in particular, in terms of processing in difficult complicated forming processing.

### DISCLOSURE

### Technical Problem

Accordingly, the present invention has been made in view of the above problems occurring in the prior art, and an object of the present invention is to provide a heating enamel glaze having a heating characteristic in which a microwave oven absorbs a microwave (2.45 GHz) and converts it into heat energy is assigned by mixing ferrite or metallic soft magnetic alloy powder material which is soft magnetic material to a commercialized glaze (glassy frit) solely or in combination.

Another object of the present invention is to provide a heating vessel capable of improving heating performance, a heat-resistance property, and convenience and lowering the manufacturing cost by coating the enamel heating glaze of the present invention on metal material for enamel.

### Technical Solution

To achieve the above objects, a heating enamel glaze of the present invention is fabricated by adding water of 20-50 parts by weight to a mixture of 100 parts by weight in which soft magnetic powder of 20 to 93 weight %, clay of 1 to 10 weight %, and sodium nitride of 0.1 to 1 weight % are mixed with an enamel glaze (glassy frit) of 5 to 75 weight % having a glassy component.

The soft magnetic powder comprises ferrite series powder or soft magnetic metal alloy powder, the ferrite series powder is selected from the group consisting of MnZn series powder, MgCuZn series powder, NiZn series powder, and a mixture thereof, and the soft magnetic metal alloy powder is selected from the group consisting of Fe—Si series, Fe—Si—Al series, Fe—Si—B series, Fe—Si—B—Co series, Fe—Ni series, Fe—Ni—Mo series, Fe—Co series, Fe—Cr series, Fe—Cr—Si series, and a mixture thereof.

Borax of 0.1 to 10 parts by weight is further added to the mixture of 100 parts by weight.

The heating vessel of the present invention is fabricated by coating the heating enamel glaze on a cooking vessel made of metal material and performing drying and glassification plasticity. The heating vessel includes a pizza plate for a microwave oven, a tray for a microwave oven, a roast fish plate for a microwave oven, and a cooking tray.

### Advantageous Effects

As described above, in the present invention, an enamel steel sheet vessel is covered with enamel by using a composed glaze composed by mixing and adding soft magnetic material powder to a commercial enamel glaze composition. Accordingly, there are advantageous in that the heating enamel for a microwave oven, having a heating characteristic in which a microwave oven absorbs a microwave (2.45 GHz) and converts it into heat energy, can be fabricated using a low manufacturing cost in the existing enamel manufacturing process and the heating enamel can withstand higher temperature than a heating vessel product (silicon rubber+ferrite) for the existing microwave oven and has heating performance.

Furthermore, the conventional heating vessel (silicon rubber +ferrite) for a microwave oven has a heating temperature of about 200 to 230 when being heated for 3 minutes within the microwave oven and is difficult to have a heating temperature higher than the above temperature. The conventional heating vessel also has an exhausted life span because silicon rubber is degraded at 280 or higher. However, the heating vessel of the present invention is advantageous in that it has a higher heating temperature than the conventional heating vessel under the same condition, the heating vessel is not degraded even at 300, and a heating temperature can be controlled.

A top of a food mounted on the heating vessel of the present invention is cooked by a high frequency and, at the same time, the bottom of the food comes into contact with the heating vessel. Accordingly, the bottom of the food into which the high frequency is not penetrated is cooked by heat generated from the heating vessel.

Furthermore, the heating vessel of the present invention has an excellent heat-resistant characteristic and can thus be used in a microwave oven combined with an electrical oven having a hot wire provided in a cooking room. Furthermore, if the heating enamel glaze of the present invention is coated on a common enamel pan, it can be used in a microwave oven and also as a common enamel pan for direct fire.

In general, enamel has an excellent processing characteristic by shaping metal material of a thin thickness in various forms, coating an enamel glaze, and then performing annealing. The coated glass material has excellent corrosion resistance and anti-abrasion heat-resistance property and has a beautiful surface characteristic. Accordingly, the coated glass material has been used in an environment having a poor corrosion or heating condition, in external decoration, and in cooking, such as a fire grate for pan roast because it is harmless to the human body even at high temperature. Despite the above advantages, the coated glass material could not be used as a heating vessel for a microwave oven because the microwave oven does not have a heating characteristic using a high frequency of 2.45 GHz. However, the heating enamel glaze of the present invention can also be used in temperature of 300 or higher because it has a higher heating temperature than the existing heating vessel for a microwave oven by solving the problems.

### DESCRIPTION OF DRAWINGS

Further objects and advantages of the invention can be more fully understood from the following detailed description taken in conjunction with the accompanying drawings in which:

FIGS. 1 to 3 show examples of metallic cooking vessels, wherein FIG. 1 shows a Jungol pan, FIG. 2 shows a steam cooker, and FIG. 3 shows a pizza roast plate;

FIGS. 4 and 5 show examples of metallic cooking vessels and show examples of dedicated heating vessel which are received in a microwave oven or a complex microwave oven;

FIGS. 6A to 6E are cross-sectional views of the metallic cooking vessel on which heating enamel glaze of the present invention is coated and show exampled in which the heating enamel glaze is coated on an external bottom surface;

FIGS. 7A to 7D are cross-sectional views of the metallic cooking vessel on which the heating enamel glaze of the present invention is coated and show examples in which the heating enamel glaze is coated on the inside bottom surface;

FIGS. 8A and 8B are cross-sectional views of the metallic cooking vessel on which the heating enamel glaze of the present invention is coated and show examples in which the heating enamel glaze is coated on the entire surface of the metallic cooking vessel; and

FIG. 9 are photographs of the metallic cooking vessel after the heating enamel glaze is coated on the surface of the metallic cooking vessel as shown in FIG. 8A.

### DESCRIPTION OF REFERENCE NUMERALS OF PRINCIPAL ELEMENTS IN THE DRAWINGS

10: metallic cooking vessel

11: common enamel glaze

12: heating enamel glaze of the present invention

13: ceramic coating glaze

### MODE FOR INVENTION

The construction and operation method of the present invention is described in detail with reference to the accompanying drawings.

A heating glaze of the present invention is fabricated by adding water of 20-50 parts by weight to a mixture of 100 parts by weight in which soft magnetic powder of 20 to 93 weight %, clay of 1 to 10 weight %, and sodium nitride of 0.1 to 1 weight % are mixed with an enamel glaze (glassy frit) of 5 to 75 weight % having a glassy component. The glaze is a heating enamel glaze that is heated by electromagnetic waves.

A heating vessel having the heating enamel glaze coated thereon is fabricated by pre-processing metal material (steel plate, aluminum, or stainless) used in the enamel, coating the heating enamel glaze on a surface, performing glassification plasticity, and performing cooling.

Here, the ‘(common) enamel glaze of the glassy component’ is glassy frit and refers to all commercial enamel glazes, having their compositions and content changed according to a type, plastic temperature, and other physical properties of a steel plate which is material of the vessel and having major compositions SiO₂, Na₂O, K₂O, CaF₂, Al₂O₃, B₂O₃, P₂O₅, Sb₂O₃, CoO, ZnO, BaO, CaO, SrO, TiO₂, ZrO, Li₂O, NiO, MnO, and SnO₂. The enamel glazes have slightly different compositions according to the materials or uses of vessels, and examples of the enamel glazes according to the types are as follows.

### EXAMPLE 1

### Composition of an Enamel Glaze for a Low Carbon Steel Plate

Na₂O: 15.4 parts by weight, K₂O: 2 parts by weight, CaO: 1.5 parts by weight, BaO: 2.7 parts by weight, NiO: 2.5 parts by weight, CaO: 8 parts by weight, SiO₂: 42 parts by weight, A₂O₃: 3.3 parts by weight, MnO₂: 0.6 parts by weight.

### EXAMPLE 2

### Composition of an Enamel Glaze for a Low Carbon Steel Plate

Na₂O: 9.8, K₂O: 2.5, Li₂O: 4.0, CaO: 1.5, BaO: 0.2, NiO: 0.2, CaO: 1.1, F2: 1.2, SiO₂: 64.5, A₂O₃: 0.5, B₂O₃: 10.5, TiO₂: 3.8, MnO₂: 0.2.

### EXAMPLE 3

### Composition of a Glaze of Aluminum

silicon dioxide (SiO₂) 26 to 30 weight %, lithium superoxide (LiO₂) 4 to 5 weight %, tin dioxide (SnO₂) 30 to 34 weight %, potassium hydroxide 14 to 18 weight %, TiO₂ 6 to 8 weight %, niter 5 to 6 weight %, potassium nitrate 3 to 5 weight %, antimony (Sb) 0.5 to 1 weight %, cadmium (Cd) 0.4 to 1 weight %.

### EXAMPLE 4

### Far-Infrared Radiation Glaze

feldspar 7 to 20%, fluorite 2 to 8%, borax 20 to 35%, cobalt (Co) 0.1 to 2%, elvan 20 to 40%, alumina 5 to 17%, nickel oxide 1 to 1.2%, niter 3 to 4%, soda ash 4 to 6%, manganese 0.5 to 5%.

The two kinds of the compositions of the enamel glazes for low carbon steel plates have been disclosed, but not necessarily limited. The compositions of the enamel glazes are only examples for a description or understanding, but not necessarily limited to the above compositions.

Furthermore, the ‘soft magnetic powder’ means powder having magnetism and refers to ferrite powder or soft magnetic metal alloy powder. The ferrite powder includes MnZn series, MgCuZn series, or NiZn series, but not limited thereto. In addition, soft magnetic ferrite may be used. The soft magnetic metal alloy powder includes Fe—Si series, Fe—Si—Al series, Fe—Si—B series, Fe—Si—B—Co series, Fe—Ni series, Fe—Ni—Mo series, Fe—Co series, Fe—Cr series, or Fe—Cr—Si series, but not limited thereto. In addition, soft magnetic metal alloy powder may be included.

The powder preferably has a size of 100 or lower and may have a circle or a sheet shape. When being mixed, one kind or two kinds or higher may be mixed in the powder.

This ‘soft magnetic powder’ is also used as an electromagnetic wave absorbent for reducing electromagnetic noise in an electronic component. This takes an advantage of a characteristic in which the soft magnetic material absorbs the electromagnetic waves of a microwave through magnetic loss and converts it into heat energy.

In the present invention, heating effect rather than the electromagnetic absorbing function of the soft magnetic (powder) material is used. The heating glaze having heating performance according to the microwave, fabricated as described above, tends to have higher heating temperature as an increased in the content of the soft magnetic material. If too much content is added, a combination state with the metal for enamel is lowered owing to the shortage of glassy content, and physical properties other than the strength tend to be degraded.

If some of the metal soft magnetic powder is mixed or one kind of metal powder solely or two kinds or higher of metal powders are mixed and use rather than using ferrite solely, heating performance and the strength are improved. The soft magnetic metal powder has a similar coefficient of thermal expansion to the metal for enamel rather than ceramic and is advantageous in that it has an excellent strength and a combination with the metal for enamel.

Since an enamel glassy surface brilliance is changed according to the type, content, and particle size of the magnetic powder, it is controlled according to the purpose of the heating vessel. The heating enamel glaze is fabricated by determining the glaze composition ratio of the heating enamel a described above, mixing and pulverizing the composition using a ball mill, and controlling the amount of moisture according to a concentration suitable for a coating method.

The “clay” is an aggregate of natural minute particles, has plasticity in the state where moisture is applied, has elasticity when being dried, and has a sintering characteristic when being roasted at high temperature. Accordingly, if the clay is added to the glaze including moisture, it has high viscosity because plasticity is improved and is advantageously coated on a surface of the metal for enamel to a specific thickness. Accordingly, after the glaze is dried after being coated, it has elasticity.

The “sodium nitride (NaNO₂)” functions to raise viscosity so that the glaze does not continue to flow if the metal for enamel is dipped and coated on the glaze including moisture.

Preferably, borax may be added. Borax is used to lower temperature in the glassification plasticity step after glaze processing. That is, if glassification plasticity is performed or borax is added in normal (when borax is not added) 820 to 850, glassification plasticity cannot be performed at 740 to 780. If aluminum is used as a steel plate, glassification plasticity can be performed at a lower temperature.

Meanwhile, in addition to water mixed in the mixture, a volatile solvent, such as thinner or alcohol, may be added in order to raise the dry speed.

A method of fabricating the heating cooking vessel for a microwave oven using the heating enamel glaze is described below.

First, pre-processing for performing acid wash and neutralization for the metal for enamel (steel plate, aluminum, or stainless) so that the heating enamel glaze is fully coated on a surface is performed.

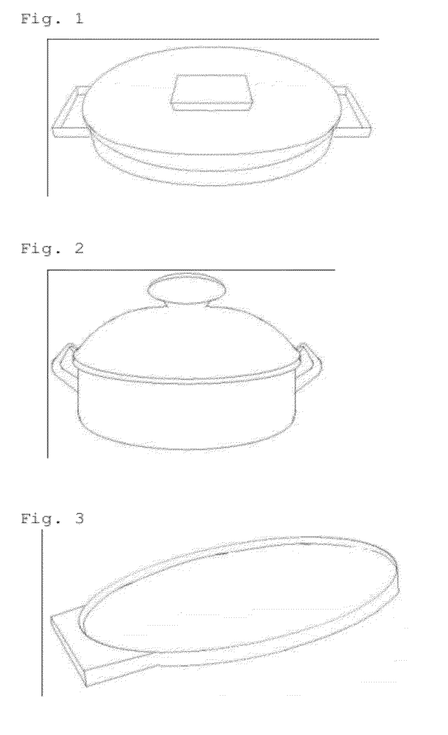

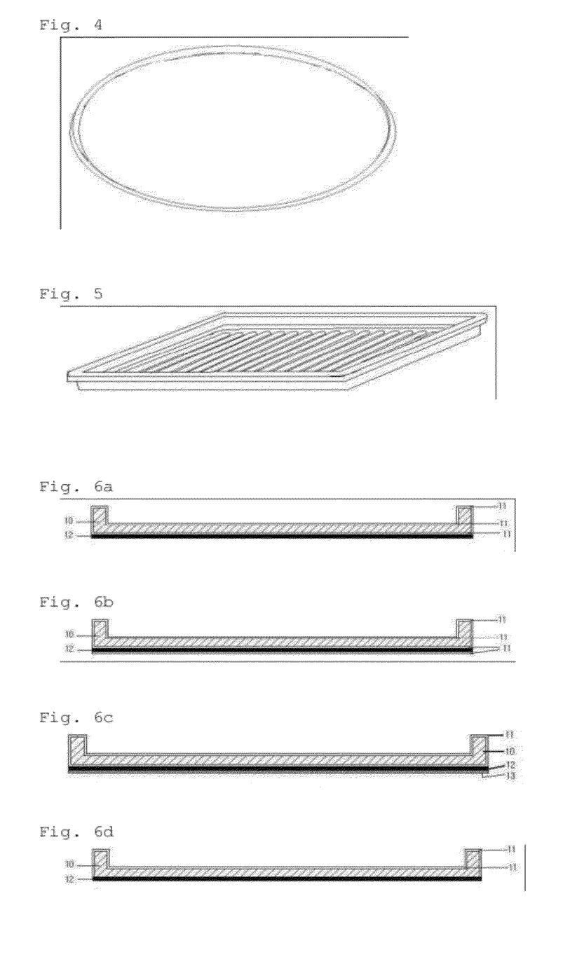

After the heating enamel glaze is uniformly coated on the surface of the metallic cooking vessel, glassification plasticity is performed by applying high temperature. The heating vessel for a microwave oven is formed by assigning a characteristic that the vessel is heated in the microwave oven in a common enamel vessel that is not heated in the microwave oven according to its purpose. An object of the heating vessel is to be used in a dedicated heating cooking vessel suitable for the standards of various microwave ovens and a complex microwave oven, such as that shown in FIGS. 4, 5 which may be installed in the bottom, middle, or top of the enamel vessels for various roasts, such as a pizza roast plate, a Jungol pan, and a steam cooker, such as that shown in FIGS. 1, 2, and 3, and the microwave oven cooking room.

In order for the heating vessel to be applied to the variety of heating vessels, a coating method, a coating thickness, and the coating number of times of the heating enamel glaze may be different according to a heating temperature, a surface brilliance, a mechanical strength, a thermal shock, a color, and a shape of the heating vessel.

The glassification plastic temperature is different at 400 to 500 when the metal for enamel is aluminum alloy and 740 to 850 in case of a steel plate for low carbon enamel according to a plasticized metal for enamel. The plastic temperature of the glaze may be controlled by controlling a composition for a low temperature or a high temperature according to the manufacturing process and product characteristic of a product.

In order to implement the various heating vessels for microwave ovens using the heating enamel glaze as described above, a method of coating the enamel glaze on the metal for enamel is also an important factor.

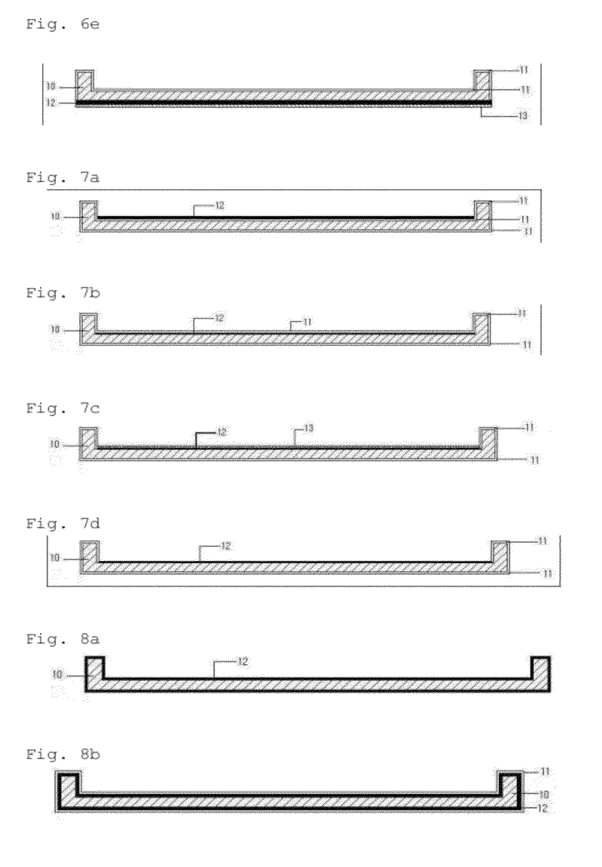

FIGS. 6A to 6E show examples in which the heating enamel glaze is coated on an external bottom surface. As shown in FIGS. 6A and 6D, after a common enamel glaze 11 is coated on the metal for enamel 10, the heating enamel glaze 12 of the present invention may be coated on the external bottom surface. It may be applied to a pan or a roast plate that is not problematic although an external bottom surface is flat. As shown in FIG. 6B, the common enamel glaze 11 may be further coated on the heating enamel glaze 12. If the external bottom surface needs to be glossy, a ceramic coating glaze 13 or a glossy glaze may be coated as shown in FIG. 6B or FIG. 6E.

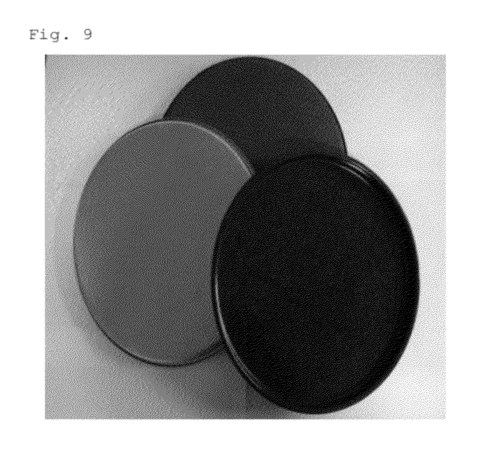

FIGS. 7A to 7D show example in which the heating enamel glaze is coated on an inside bottom surface. FIG. 7A shows an example in which the common enamel glaze 11 is entirely coated on the metal for enamel 10 and the heating enamel glaze 12 is then coated on the inside bottom surface. FIG. 7B shows an example in which the common enamel glaze 11 is coated on portions of the metal for enamel 10 other than the inside bottom surface, the heating enamel glaze 12 is coated on the inside bottom surface, and the common enamel glaze is coated thereon. FIG. 7C shows an example in which the ceramic coating glaze 13 or the glossy glaze is coated on the heating enamel glaze 12. FIG. 7D shows an example in which the common enamel 11 is coated on portions of the metal for enamel 10 other than the inside bottom surface and only the heating enamel glaze 12 is coated on the inside bottom surface.

FIGS. 8A to 8B show examples in which the heating enamel glaze is coated on the entire surface of a metallic cooking vessel. FIG. 8A shows an example in which only the heating enamel glaze 12 is coated, and FIG. 8B shows an example in which the common enamel glaze 11 is coated on the heating enamel glaze 12. If a surface brilliance is lowered, the enamel glaze may be additionally coated by controlling glossy or color.

As described above, the method of coating the heating enamel glaze may be selected according to the purpose, production process, heating temperature, and other necessary characteristics of a heating enamel.

Hereinafter, the present invention is described in detail with reference to embodiments.

### Embodiment 1

A glaze sample for heating enamel was fabricated by adding clay and sodium nitride (NaNO₂) to glassy frit for a commercial enamel glaze [a composition of SiO₂, Al₂O₃, Na₂O, K₂O, CaO, NiO, CoO, CuO, MnO, BaO, F, B₂O₃, etc.] while changing the type and content of ferrite and soft magnetic metal alloy powder (FeSiAl series, FeSi series) which are soft magnetic material according to commercial glaze composition added as in Table 1 below, determining a composition ratio of twelve kinds of glazes, adding water of wt % to the composition, and pulverizing it using an alumina ball mill in an average particle size of 100.

A sample having a thickness of 0.8 mm and a square of 100*150 mm was fabricated using a commercial hot rolling plate for enamel. Fat of the steel plates was removed using sodium hydroxide (NaOH). The heating enamel glaze was coated in thickness of 200 or higher and then dried at 100 for 2 hours. The glaze layer of the dried sample is subjected to glassification plasticity in a furnace at 830 for 5 minutes and then abruptly cooled in air. A heating effect according to the microwave of the sample was measured, and the results were shown in Table 2 below.

TABLE 1
Composition

| | Mixing ratio (wt %) | | | | | |
|---|---|---|---|---|---|---|
| | | Soft magnetic powder | | | | |
| | | Soft | Soft | | | |
| | | magnetic | magnetic | | | |
| | | metal | metal | Ferrite | | Sodium |
| | Enamel | powder | powder | powder | | nitride |
| Embodiments | glaze | (FeSiAl) | (FeSi) | (MnZn-Ferrite) | Clay | (NaNO₂) |
| Embodiment 1 | 52.5 | 43.8 | | | 3.5 | 0.2 |
| Embodiment 2 | 44.4 | 51.8 | | | 3.6 | 0.2 |
| Embodiment 3 | 41.2 | 55 | | | 3.6 | 0.2 |
| Embodiment 4 | 24.0 | 71.9 | | | 4.0 | 0.2 |
| Embodiment 5 | 19.2 | 76.7 | | | 3.9 | 0.2 |
| Embodiment 6 | 41.2 | | 55 | | 3.6 | 0.2 |
| Embodiment 7 | 70.9 | | | 23.6 | 5.3 | 0.2 |
| Embodiment 8 | 63.0 | | | 31.5 | 5.3 | 0.2 |
| Embodiment 9 | 40.2 | | | 53.6 | 6.0 | 0.2 |
| Embodiment 10 | 38.5 | | | 57.8 | 3.5 | 0.2 |
| Embodiment 11 | 29.5 | 54.3 | | 12 | 4.0 | 0.2 |
| Embodiment 12 | 22.5 | 61.4 | | 12 | 3.9 | 0.2 |

TABLE 2
Heating temperature measurement results

| | Heating temperature measurement | | | | Thermal | |
|---|---|---|---|---|---|---|
| | results (1000 W microwave oven,) | | | | shock | |
| | 1 | 2 | 3 | 5 | (rapid | |
| | minute- | minute- | minute- | minute- | cooling | |
| Embodiments | heating | heating | heating | heating | at 350) | Notes |
| Embodiment 1 | 220 | 230 | 257 | 266 | | : |
| Embodiment 2 | 179.5 | 251 | 273 | 280 | | Excel- |
| Embodiment 3 | 233 | 282 | 290 | 319 | | lent |
| Embodiment 4 | 233 | 311 | 313 | 320 | | ∘: |
| Embodiment 5 | 266.5 | 334 | 343 | 350.5 | | Good |
| Embodiment 6 | 223 | 248 | 267 | 280 | | : |
| Embodiment 7 | 97 | 138.5 | 152.5 | 163.5 | ∘ | Normal |
| Embodiment 8 | 150 | 124 | 166 | 168 | ∘ | |
| Embodiment 9 | 162 | 207 | 212 | 213 | | |
| Embodiment | 169 | 208 | 220 | 224 | | |
| 10 | | | | | | |
| Embodiment | 232 | 308 | 337 | 337 | ∘ | |
| 11 | | | | | | |
| Embodiment | 240 | 309 | 321 | 342 | ∘ | |
| 12 | | | | | | |

From the embodiment 1 of Table 1 and Table 2, it can be seen that, if the heating enamel sample fabricated by adding FeSiAl series powder of 43.8 wt % (that is, metal magnetic powder) to a commercial enamel glaze composition is heated within the 1000W microwave oven for 3 minutes, the heating effect of a microwave (2.45 GHz) in which a surface temperature of the sample rose to 257 could be seen.

Furthermore, if the content of FeSiAl series powder (that is, metal magnetic powder) is increased as in the embodiments 1, 2, 3, 4, and 5 of Table 1 and Table 2, it can be seen that the heating temperature of the fabricated sample gradually rose. It could also be seen that a combination state with steel for enamel was good, the sample was not easily damaged by a shock, a crack was not generated in the sample although the sample of 350 was abruptly cooled in room temperature, and the sample had a good thermal shock property.

In the embodiment 6 of Table 1 and Table 2, even though the heating enamel glaze was fabricated by replacing FeSiAl series (that is, metal magnetic powder) with FeSi series (that is, metal magnetic powder), when the sample was heated within the 1000 W microwave oven for 3 minutes, a heating effect according to the microwave (2.45 GHz) in which the surface temperature of the sample rose to 267 could be checked, but it could be seen that heating performance was slightly lowered as compared with the embodiment 3 in which FeSiAl series metal magnetic powder was added with the same content.

Furthermore, the embodiments 7, 8, 9, and 10 of Table 1 and Table 2 show that the heating enamel glaze was fabricated using the same method by controlling the content to 23.6 to 57.8 wt % by replacing the metal magnetic powder with MnZn series ferrite (that is, magnetic ceramic), the heating enamel sample was fabricated using the heating enamel glaze, and a heating effect according to the microwave (2.45 GHz) was measured. If the content of MnZn series ferrite (that is, magnetic ceramic) was increased, a heating effect according to the microwave (2.45 GHz) in which the surface temperature of the sample rose to 220 if the sample was heated within the 1000 W microwave oven for 3 minutes could be checked. However, the heating effect was slightly lowered as compared with soft magnetic metal powder.

In the embodiments 11 and 12, if soft magnetic metal powder and ferrite were mixed, there was a tendency that the heating effect was slightly lowered as compared with a case where the soft magnetic metal powder was solely used. However, they could be mixed and used according to the characteristic of a product.

Next, the heating enamel glaze was fabricated using the above method by controlling the composition and content of the heating enamel glaze. The fabricated heating enamel glaze having a coating amount (g/cm²) of 0.14 to 0.3 g/cm² per unit are was coated on the enamel sample fabricated to have an actual size of a microwave oven dedicated vessel, dried, subjected to glassification plasticity, and then dried to produce the enamel sample. This is shown in Table 3.

TABLE 3
composition, the standard of the sample, and the amount of coating

| | |
|---|---|
| Composition (wt %) of heating enamel | Heating enamel |
| glaze | sample |

| | | Soft | | | | standard | |
|---|---|---|---|---|---|---|---|
| | | magnetic | Ferrite | | | | Amount |
| | Enamel | metal | powder | | Sodium | Vessel | of |
| | glaze | powder | (MnZn- | | nitride | standard | coating |
| Embodiments | (frit) | (FeSiAl) | Ferrite) | Clay | (NaNO₂) | (mm) | (g/cm²) |
| Embodiment 13 | 14.6 | 76.7 | 5.1 | 3.4 | 0.2 | Φ206 | 0.15 |
| Embodiment 14 | 14.6 | 81.8 | | 3.4 | 0.2 | Φ206 | 0.14 |
| Embodiment 15 | 19.2 | 76.7 | | 3.9 | 0.2 | Φ206 | 0.15 |
| Embodiment 16 | 19.2 | 76.7 | | 3.9 | 0.2 | Φ206 | 0.21 |
| Embodiment 17 | 19.2 | 76.7 | | 3.9 | 0.2 | 328 * 233 | 0.23 |
| Embodiment 18 | 19.2 | 76.7 | | 3.9 | 0.2 | 328 * 233 | 0.3 |

Each of the enamel samples of the embodiments 13 to 18 was put into the 1000 W microwave oven, a heating temperature was measured, and results thereof was listed in Table 4.

TABLE 4
Heating temperature

| | Heating temperature | | | |
|---|---|---|---|---|
| | measurement results | | | |
| | (1000 W microwave oven,) | | | |
| | 1 minute- | 2 minute- | 3 minute- | 5 minute- |
| Embodiments | heating | heating | heating | heating |
| Embodiment 13 | 123.5 | 180 | 208 | 256 |
| Embodiment 14 | 129 | 206 | 244 | 273 |
| Embodiment 15 | 137 | 188.5 | 223 | 272 |
| Embodiment 16 | 162 | 225 | 260 | 305 |
| Embodiment 17 | 130 | 207 | 215 | 286 |
| Embodiment 18 | 117 | 199 | 231 | 290 |

Referring to the table, it can be seen that, if the content of metal magnetic powder is increased in the embodiment 14 and the embodiment 15, temperature rises upon heating in the microwave oven for 3 minutes and the heating temperature rises according to an increase in the amount (thickness) of the heating enamel glaze per unit area of the enamel vessel as compared with the embodiment 15, the embodiment 16, the embodiment 17, and the embodiment 18.

Furthermore, it can be seen that, if the heating enamel glaze is coated under the same condition and heating temperature is measured under the same condition, the heating temperature is lowered according to an increase in the size of the enamel vessel as compared with the embodiment 16 and the embodiment 17. That is, the heating temperature of the heating enamel can be controlled by controlling the type and content of magnetic material used in the heating enamel glaze and the weight (thickness) of the glaze per unit area of the enamel vessel to be coated according to the size of the heating enamel vessel. Accordingly, it can be seen that the heating enamel vessel for a microwave oven suitable for purposes can be designed.

Furthermore, a conventional heating vessel (silicon rubber+ferrite) for microwave oven has a heating temperature of about 200 to 230 when being heated within the microwave oven for 3 minutes and may have a heating temperature higher than 200 to 230. The silicon rubber of the conventional heating vessel is abruptly degraded at 280 or higher and has its life span exhausted. However, it could be seen that the product of the present invention has a high heating temperature under the same condition, the product is never degraded even at 300, and the heating temperature of the product can be controlled.

### INDUSTRIAL APPLICABILITY

1. A heating enamel glaze coated on a surface of a vessel made of metal material and configured to heat the metallic vessel, wherein the heating enamel glaze is fabricated by adding water of 20-50 parts by weight to a mixture of 100 parts by weight in which soft magnetic powder of 20 to 93 weight %, clay of 1 to 10 weight %, and sodium nitride of 0.1 to 1 weight % are mixed with an enamel glaze (glassy frit) of 5 to 75 weight % having a glassy component.

2. The heating enamel glaze according to claim 1, wherein:
the soft magnetic powder comprises ferrite series powder or soft magnetic metal alloy powder,
the ferrite series powder is selected from the group consisting of MnZn series powder, MgCuZn series powder, NiZn series powder, and a mixture thereof, and
the soft magnetic metal alloy powder is selected from the group consisting of Fe—Si series, Fe—Si—Al series, Fe—Si—B series, Fe—Si—B—Co series, Fe—Ni series, Fe—Ni—Mo series, Fe—Co series, Fe—Cr series, Fe—Cr—Si series, and a mixture thereof.

3. The heating enamel glaze according to claim 1 or 2, wherein borax of 0.1 to 10 parts by weight is further added to the mixture of 100 parts by weight.

4. A cooking heating vessel of metal material which is fabricated by coating a heating enamel glaze, fabricated by adding water of 20-50 parts by weight to a mixture of 100 parts by weight in which soft magnetic powder of 20 to 93 weight %, clay of 1 to 10 weight %, and sodium nitride of 0.1 to 1 weight % are mixed with an enamel glaze (glassy frit) of to 75 weight % having a glassy component, on the cooking heating vessel of the metal material, dried, and subjected to glassification plasticity.

5. The heating vessel according to claim 5, wherein the heating vessel comprises a pizza plate for a microwave oven, a tray for a microwave oven, a roast fish plate for a microwave oven, and a cooking tray.

6. The heating vessel according to claim 4 or 5, wherein:
the soft magnetic powder comprises ferrite series powder or soft magnetic metal alloy powder,
the ferrite series powder is selected from the group consisting of MnZn series powder, MgCuZn series powder, NiZn series powder, and a mixture thereof, and
the soft magnetic metal alloy powder is selected from the group consisting of Fe—Si series, Fe—Si—Al series, Fe—Si—B series, Fe—Si—B—Co series, Fe—Ni series, Fe—Ni—Mo series, Fe—Co series, Fe—Cr series, Fe—Cr—Si series, and a mixture thereof.

7. The heating vessel according to claim 6, wherein borax of 0.1 to 10 parts by weight is further added to the mixture of 100 parts by weight.
